(19) United States
(12) Patent Application Publication
(10) Pub. No.: US 2023/0056911 A1
(43) Pub. Date: Feb. 23, 2023

(54) INFINITELY VARIABLE FOOD WASHER AND METHOD THEREOF

(71) Applicant: Unified Brands, Inc., Vicksburg, MS (US)

(72) Inventors: Michael P. Licata, Lee's Summit, MO (US); Robert J. McNamara, Holliston, MS (US)

(21) Appl. No.: 17/891,764

(22) Filed: Aug. 19, 2022

Related U.S. Application Data
(60) Provisional application No. 63/235,269, filed on Aug. 20, 2021.

(51) Int. Cl. A23N 12/02; G05B 13/04

(52) U.S. Cl. CPC A23N 12/023; G05B 13/04

(57) ABSTRACT

A washing machine with an infinitely variable pump is provided. The infinite variable pump is a fluid pump with pumping speeds which are uncountably infinite, in such that it has a maximum value and a minimum value for its pumping speed, but is otherwise configured to allow a user to select any pumping speed of the uncountable set between these pre-set limits. The pump may utilize a variable frequency drive (VFD). The VFD uses an inverter duty motor instead of a normal induction motor. The VFD is incorporated within the pump. The VFD is wired into the pump motor circuit between the machine power switch and the motor. Such a configuration allows for a ground-up build of a washing machine incorporating the infinitely variable pump or a retrofitting of an existing wash tank to incorporate the infinitely variable pump.

### CROSS-REFERENCE TO RELATED APPLICATIONS

This application claims priority pursuant to 35 U.S.C. 119(e) to co-pending U.S. Provisional Patent Application Ser. No. 63/235,269, filed Aug. 20, 2021, the entire disclosure of which is incorporated herein by reference.

This application incorporates herein by reference the entire disclosures of:
U.S. Pat. No. 8,685,170, filed Jul. 23, 2010; and
U.S. Provisional Patent No. 61/228,007, filed Jul. 23, 2009.

### FIELD OF THE INVENTION

The present invention relates generally to washing machines. More specifically, the present invention is concerned with infinitely variable food washers and adjustment of washing cycles utilizing infinitely variable flow based on a variety of factors.

### BACKGROUND

Traditional powered food washing applications have utilized pumps with fixed fluid flow rates. The fixed fluid flow rates were chosen for food products of average size and average fragility. The resultant flow rate is acceptable for food products of average size and average fragility, but lead to issues with both incomplete washing and damage for items which fell beyond the average range. For example, such a singular flow rate is too low to properly clean heavy food products such as melons, baking potatoes, and whole heads of Romaine lettuce, while at the same time also being too high to avoid damage to fragile food items such as raspberries, apricots, and blueberries. While dual-flow or even pre-determined multi-flow pumps have been utilized, the same fundamental problem exists—pre-set flow rates cannot sufficiently cover all use cases and will necessarily fail to perform adequately when utilized in situations which are not covered by these pre-set flows. Accordingly, it would be advantageous to have a pump with an infinitely adjustable flow rate so as to be adaptable to all use cases.

### SUMMARY

The present invention comprises a system and method of utilizing an infinitely variable pump with a washing machine. The system and method consider a washing machine which is either initially manufactured with an infinitely variable pump or later retrofitted with such a pump. The infinitely variable pump is a fluid pump with pumping speeds which are generally uncountably infinite. Said another way, the pump speeds are analog, not digital. The pump utilizes a variable frequency drive and a controller, along with one or more sensors positioned about the washing machine and operable connected to the controller which inform the system and one or more user of one or more status or data of the machine. Advantageously, the system and method enable monitoring of washing parameters and precise adjustment of the flow rate of the pump to adapt to both static and dynamic washing environments.

In some embodiments, the system and method include a control panel which is operable connected to both the pump and one or more sensor. The control panel includes a memory couple to a processor, the memory containing machine readable code to execute one or more of the functions described herein. In some embodiments, the control panel functions to provide a user interface, monitor one or more values associated with one or more sensors, and adjust one or more function of the washing machine and one or more speed level of the pump based on one or more user inputs, pre-set values, sensor readings, and the like. In this way, the control panel advantageously provides both pre-set washing cycles as well as dynamic washing cycles which adjust to the washing environment in real time, thereby enabling the proper treatment of any and all articles within the wash tank.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

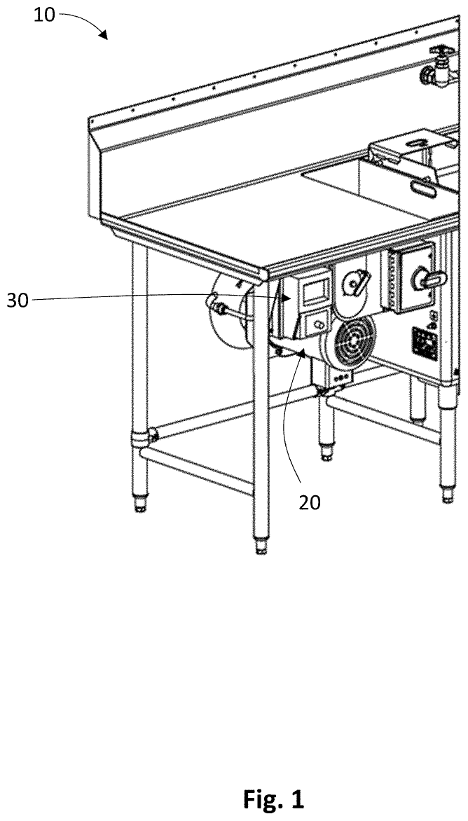

FIG. 1 is a perspective view of a wash tank with an infinitely variable pump according to one embodiment of the present invention.

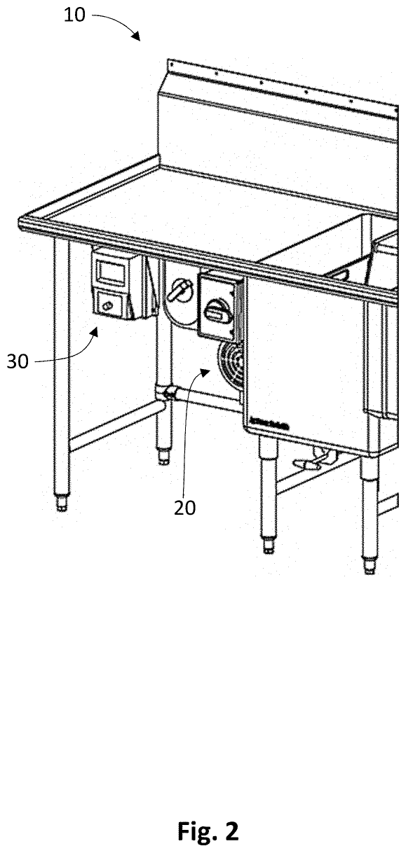

FIG. 2 is a perspective view of a wash tank with an infinitely variable pump according to one embodiment of the present invention.

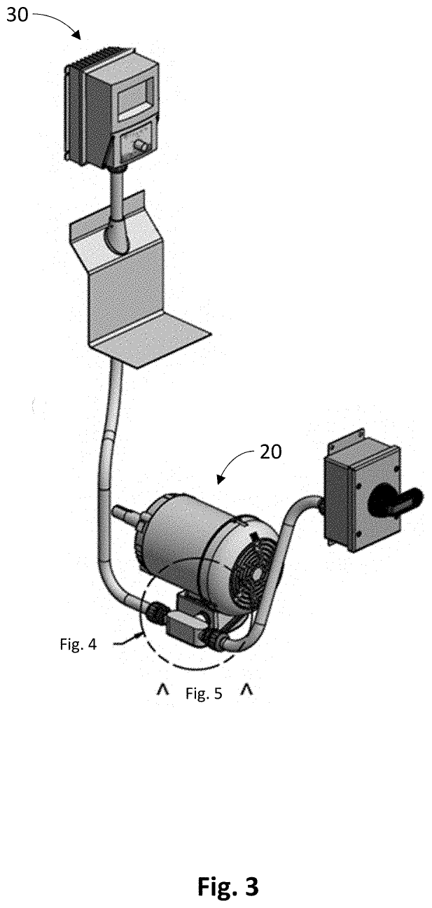

FIG. 3 is a perspective view of an infinitely variable pump according to one embodiment of the present invention.

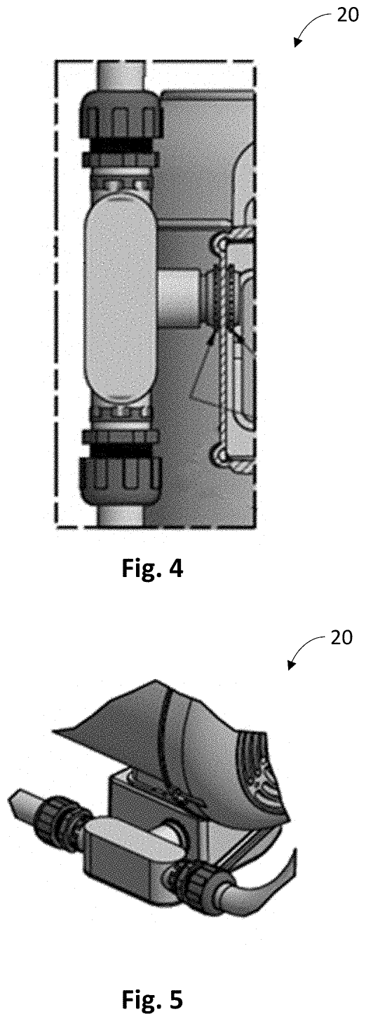

FIG. 4 is a section view as shown in FIG. 3.

FIG. 5 is a detail view as shown in FIG. 3.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises a washing machine which utilizes an infinitely variable pump. In one embodiment, an embodiment of the washing machine depicted in U.S. Pat. No. 8,685,170 (the “'170 patent”). is utilized with an infinite variable pump. The infinite variable pump is a fluid pump with pumping speeds which are generally uncountably infinite, in such that it has a maximum value and a minimum value for its pumping speed, but is otherwise configured to allow a user to select any pumping speed of the generally uncountable set between these pre-set limits. In some embodiments, the pump is considered to be analog in its adjustability, as opposed to digital pump selections. In some embodiments, the pump utilizes a variable frequency drive (VFD). In some embodiments, the VFD uses an inverter duty motor instead of a normal induction motor. In some embodiments, the VFD is incorporated within the pump. In some embodiments, the VFD is wired into the pump motor circuit between the machine power switch and the motor. Such a configuration allows for a ground-up build of a washing machine incorporating the infinitely variable pump or a retrofitting of an existing washing machine, such as the one shown in the '170 patent.

In some embodiments, the VFD is programmed to tailor its performance to the specific food washing application, such as the specific wash tank or intended utilization of the application. In some embodiments, such tailoring includes pre-set minimum and maximum speeds, overload conditions, and acceleration rates which best suit the specific food washing system to maximize its efficacy. In some embodiments, the VFD is integrated into the pump motor. In some embodiments, the VFD is wired directly into the pump motor circuit between the machine power switch and the motor windings.

The washing machine of the present invention with an infinite variable pump provides for a wide range of wash settings that can be tailored to suit specific tastes and requirements. These include but are not limited to pre-set minimum and maximum speeds, as well as programmable acceleration rates which best suit a specific food washing system to maximize its efficacy. Washing machines equipped with such pumps can be used in a wide range of applications including commercial dishwashers, home dishwashers, laundry machines for both home and commercial use, and even industrial parts washers. Due to their wide range of speeds and ability to be programmed to match specific applications, infinite variable pumps are particularly well suited for delicate items which require gentler cleaning action such as fine china or other breakables. The wide range of speeds also allows for user customization and experimentation with different settings to find those which work best for their own personal needs and desired results.

In some embodiments, where retrofitting is concerned, commercial kitchens often have pieces of equipment butted up against each other end-to-end. In some embodiments, where there is no opening between a food washer and adjacent equipment, the conduit connecting the motor, VFD, and control enclosure necessarily passes through the backsplash of the food washer. In such embodiments, components developed for this purpose are easily retrofittable and also easily sanitized to agency standards and are shown in FIG. 1.

In some embodiments, the VFD has broad acceptability of electrical connections. In some embodiments, such acceptability is configured to accommodate for the standards utilized in many of the countries in the world without the need for modification. In some embodiments, this range of 90-132 VAC, 1˜, 48-62 Hz is accommodated by the VFD. Such range is sufficient to power the VFD. Consequently, the standard controls configuration will be adequate for the majority of countries in the world.

In some embodiments, adjustment of the flow rate of the infinitely variable pump is based on one or more variable of the wash. In some embodiments, such variables include, but are not limited to: food type (based on fragility); size of the food items within a type category; the size of the batch of food items; the wash water temperature; the antimicrobial used; the degree of pre-preparation (bone-in, de-boned, peeled or unpeeled, Julienned, diced, chopped, and the like.); the age of the food product; and the like. In some embodiments, such adjustment based on these factors ensures that all food surfaces are cleaned, and no food product is damaged. In some embodiments, a user assesses the washing circumstances and the foregoing factors and adjusts the infinitely variable pump accordingly. In some embodiments, a guide is provided to the user which indicates adjustments to the flow based on the foregoing variables. In some embodiments, the guide is in the form of a printed document, a software application, an online calculator, or the like. In some embodiments, the user is prompted by the machine or by a control panel of the machine to input parameters related to one or more of the foregoing variables. In some embodiments, an on-board computational device then calculates and applies the appropriate wash speed based on the input variable and the configuration of the particular wash application. In some embodiments, one or more sensors associated with the wash application and/or the infinitely variable pump assess one or more of the aforementioned variables prior to and/or during a wash cycle. Based on the resulting parameters measured by the one or more sensors, an onboard processor and memory connected to sensors and the pump calculate an advantageous pump flow speed and subsequently adjust the pump to the advantageous pump flow speed. In some embodiments, this assessment is performed prior to the start of a wash cycle, while in some embodiments the assessment and adjustment is performed continuously or periodically during a wash cycles.

In some embodiments, a combined user/automated sensor approach is taken. In such embodiments, the user inputs one or more variable prior to beginning a wash cycle and the machine monitors (prior to the wash cycle and/or during the wash cycle) one or more variable itself. The onboard processor and memory utilize both the user-inputs and the sensor inputs of parameters relevant to the variables to calculate and apply an advantageous pump flow speed. In some embodiments, the onboard processor and memory are configured to recognize when the user-set parameters are no longer relevant to the ongoing washing cycle and to replace the user-set parameters with parameters detected from the one or more sensor. In some embodiments, the user-set parameters are permanent throughout the wash cycle.

Referring to FIG. 1, in some embodiments a washing machine is considered. The washing machine 10 has a housing with a wash tub or wash tank. The wash tank is filled with water through an inlet, each inlet associated with one or more jets and/or one or more section or chamber of the wash tank. The water is drained from the wash tank through a discharge conduit.

A pump 20 is operably connected to the discharge conduit and/or inlet. The pump 20 includes a motor and a variable frequency drive operably connected to the motor. The variable frequency drive is operably connected to receive a power input. The power input, in some embodiments, is either AC or DC power. The variable frequency drive generates a motor speed signal corresponding to a motor speed based on the power input. The motor speed signal changes the motor speed based on the power input. For example, the motor speed signal can increase motor speed continuously as the power input is increased from a minimum speed to a maximum speed.

The pump 20 further includes a pump housing and a pump inlet operably connected to the pump housing. The pump housing contains the motor. The pump inlet is operably connected to the discharge conduit. A pump outlet is operably connected to the pump housing.

The washing machine 10 also includes a controller 30 operably connected to the motor and the variable frequency drive. The controller 30 is operably connected to receive a user input. The controller 30 provides the power input to the variable frequency drive based on one or more variable, pre-defined value, sensor reading, user input, or the like.

The washing machine 10 also includes a flow sensor operably disposed within the wash tank and operably connected to the controller 30. The controller 30 is operably connected to the motor and the variable frequency drive. The controller 30 is operably connected to the flow sensor. The controller 30 monitors a flow rate within the wash tank. The controller 30 provides power to the variable frequency drive based on one or more reading from the sensor, along with, in some embodiments, one or more additional value.

The washing machine 10 further includes a temperature sensor operably disposed within the wash tank and operably connected to the controller 30. The controller 30 is operably connected to the temperature sensor, the motor, and the flow sensor. The controller 30 monitors a temperature within the wash tank. Based on the temperature, the controller 30 provides power to the motor through the variable frequency drive, and in some embodiments, the power is determined based on one or more additional value.

In some embodiments, the pump 20 further includes a pump impeller operably disposed within the pump inlet and operably connected to the motor. The pump impeller is operable to draw wash water into the pump inlet when the motor is operating.

In some embodiments, the controller 30 includes a memory. The memory can be any type of memory device, including but not limited to, a hard drive, a solid state drive, random access memory (RAM), read only memory (ROM), and/or a flash drive. The memory can store program instructions that, when executed by the controller 30, cause the controller 30 to perform the functions described herein.

The washing machine 10 can also include one or more sensors operably disposed within the wash tank and operably connected to the controller 30. The sensor can be any type of sensor that can detect a physical parameter of the wash water, such as but not limited to, pH, conductivity, turbidity, temperature, and/or optical density. The controller 30 is operably connected to receive an input from the sensor. Based on the input from the sensor, the controller 30 provides power to the motor through the variable frequency drive.

In some embodiments, the washing machine 10 further includes a display operably connected to the controller 30. The display can be any type of display device that can displaying information to a user, such as but not limited to, a liquid crystal display (LCD) screen, a plasma screen, an organic light emitting diode (OLED) screen, and/or a light emitting diode (LED) screen. The controller 30 is operably connected to the display to provide information to the user.

In some embodiments, the controller includes a memory couple to a processor, the memory storing machine readable code and one or more database. In some embodiments, the one or more database is associated with one or more variable, input, parameter, or the like associated with the wash system. In some embodiments, the database is a pre-defined variable database which stores pre-defined variables. In some embodiments, the database is a sensor value database, which intakes, stores, and updates sensor values. In some embodiments, the database is a user input database, which intakes, stores and updates user input data. In some embodiments, the database is a system status database, which intakes, stores, and updates system status information. In some embodiments, the database is a time database, which intakes, stores, and updates time data. In some embodiments, the database is a temperature database, which intakes, stores, and updates temperature data. In some embodiments, the database is a load database, which intakes, stores, and updates load data. In some embodiments, the database is a cycle database, which intakes, stores, and updates cycle data. In some embodiments, the database is a wash database, which intakes, stores, and updates wash data. In some embodiments, the database is a wash profile database, which intakes, stores, and updates wash profile data. It will be appreciated that the databases described herein adjustable to one or more data types. In some embodiments, the databases are movable between read-only and read-write states depending on the operating status of the wash machine. In the read only state, the controller is unable to modify the values in the database. For example, when a wash cycle begins, pre-defined values stored in a database are moved to read-only mode, so that these pre-defined values cannot be edited during the wash cycle.

In some embodiments, the database is updated by a sensor, the controller, or another device or system. In some embodiments, the database is updated by an input device coupled to the controller. In some embodiments, the database is updated by a user input device coupled to the controller, in some embodiments, the database is updated by a network coupled to the controller.

In some embodiments, the database is updated by the controller. In some embodiments, the controller updates the database by executing the machine readable code stored in the memory. In some embodiments, the machine readable code is executed by a processor couple to the memory. In some embodiments, the processor is a microprocessor, a central processing unit, a digital signal processor, a microcontroller, or a combination thereof.

In some embodiments, the pump and/or controller are operably coupled to one or more jets associated with the wash tank. In some embodiments, the controller and pump are operable to control the speed of fluid flowing from one or more of the jets, collectively and individually. For example, in some embodiments, there are 4 jets and the controller and pump are operable to ensure one of the four jets is operating at a first speed while the remaining jets operate at a second speed. In some embodiments, one or more jet is associated with one or more chamber or area of the wash tank. In some embodiments, each chamber and/or area of the wash tank includes one or more sensor which is provided one or more value to the controller. In this way, the flow of fluid in the entirety of the wash tank is monitored and adjusted in a more granular fashion. in some embodiments, the controller and pump are operable to control the speed of fluid flowing from one or more of the jets based on a value provided by one or more sensor. In some embodiments, the controller and pump are operable to control the speed of fluid flowing from one or more of the jets based on a value provided by one or more database. In some embodiments, the controller and pump are operable to control the speed of fluid flowing from one or more of the jets based on data received from a network. In some embodiments, the controller and pump are operable to control the speed of fluid flowing from one or more of the jets based on data received from an input device. In some embodiments, two or more jets in a chamber operate at different speeds. In this manner, water is selectively directed throughout the chamber to efficiently clean items within that particular chamber.

Various embodiments of the computer program, system, and method of embodiments of the present invention are implemented in hardware, software, firmware, or combinations thereof, which broadly comprises server devices, computing devices, and a communications network. Various embodiments of the server devices include computing devices that provide access to one or more general computing resources, such as Internet services, electronic mail services, data transfer services, and the like. In some embodiments the server devices also provides access to a database that stores information and data, with such information and data including, without limitation, account information, NLU model information, campaign information, personality information, or other information and data necessary and/or desirable for the implementation of the computer program, system, and method of the present invention, as will be discussed in more detail below.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device can capture, store, and transmit digital images and/or videos.

In some embodiments the computing devices includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program will actually be performed by one or more computers, processors, or other computational devices, such as the computing devices and/or server devices, independently or cooperatively executing portions of the computer program.

A user is capable of accessing various embodiments of the present invention via an electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A washing machine comprising:
a housing with a wash tank; and
a pump, the pump including:
a motor; and
a variable frequency drive operable to receive a power input and to generate a motor speed signal corresponding to a motor speed based on the power input,
wherein the motor speed signal increases motor speed continuously as the power input is increased from a minimum speed to a maximum speed.

2. The washing machine of claim 1 wherein the pump is operably connected to a controller, wherein the controller is operable to receive a first input and to provide a power input to the variable frequency drive based on the first input.

3. The washing machine of claim 2 wherein the pump further includes:
a flow sensor operably disposed within the wash tank and operably connected to the controller,
wherein the controller is operably connected to the motor;
wherein the controller is operably connected to the flow sensor,
wherein the controller is operable to monitor a flow rate within the wash tank, and
wherein the controller is operable to provide a power input to the variable frequency drive based at least partly on the flow rate.

4. The washing machine of claim 3 wherein the flow sensor is positioned within one of a plurality of chambers of the wash tank.

5. The washing machine of claim 3 wherein the pump further includes:
a temperature sensor operably disposed within the wash tank and operably connected to the controller,
wherein the controller is operably connected to the temperature sensor to monitor a temperature within the wash tank,
wherein the controller is operably connected to provide a power input to the variable frequency drive based on the temperature.

6. The washing machine of claim 5, wherein the controller is operable to provide a power input to the variable frequency drive based on a combined input of the flow rate within the wash tank and the temperature within the wash tank and further based on at least one pre-defined user input.

7. A method for customizing a washing machine, the method comprising:
determining one or more variables associated with a wash process;
determining an advantageously adjusted pump flow rate based on said one or more variables; and
adjusting the pump flow rate of said washing machine to create said advantageously adjusted pump flow rate.

8. The method of claim 7, wherein the pump flow rate is adjusted using a variable frequency drive.

9. The method of claim 8, wherein said variable frequency drive is operable connected to a controller, the controller programmed to tailor a speed of the variable frequency drive to one or more specific washing application.

10. The method of claim 9, wherein said tailoring including defining a pre-set minimum and maximum pumping speeds.

11. The method of claim 10, wherein said tailoring further includes defining acceleration rates which best suit a specific washing application to maximize its efficacy.

12. The method of claim 7, wherein said determining comprises assessment of one or more characteristic regarding the washing application, said one or more characteristic being one or more of: food type; food size; batch size; wash water temperature; antimicrobial used; degree prepreparedness; and age of food product.

13. The method of claim 7, wherein determining advantageously adjusted pump flow rate comprises: prompting a user to input parameters related to said variables; and determining pump flow rate based on one or more input provided by said user.

14. The method of claim 7, wherein determining advantageously adjusted pump flow rate comprises: assessing one or more said variables in relation to one or more respective sensors; deriving data from assessment of said variables where said data corresponds with a range of speed options relating to said washing machine; selecting the option from said range which is the most advantageous for the wash given the data derived from sensors; and applying said selection to said washing machine.

15. The method of claim 14, wherein determination of advantageously adjusted pump flow rate further comprises: prompting user input; comparing sensor data with aforementioned user input; and modifying an output based on comparison ,where said modification takes into account differences between sensor information and user input.

16. A washing machine comprising:
a housing;
an inflow conduit;
an outflow conduit;
a pump having an inlet and an outlet, wherein said pump is disposed between said inflow conduit and outflow conduit such that: water flows through said inflow conduit, enters said inflow of said pump, is pressurized within said housing, enters said outlet of said pump, and exits through outflow conduit to a discharge valve assembly, said pump having an infinitely adjustable flow rate which allows for pump speed to be set at the extremes of a pressurization speed curve.

17. The washing machine of claim 16, wherein pump speed settings are user adjustable.

18. The washing machine of claim 17, wherein pump speed settings are adjusted via control panel located on washing machine.

19. The washing machine of claim 18 further comprising:
one or more sensors configured to detect characteristics with regard to food items that will be washed in the washing machine and/or one or more variables with regard to wash cycle;
one or more pre-set limits applicable to the washing machine;
a processor and memory device connected to the one or more sensors and the pump; and
an infinite variable pump programmed with an algorithm which takes information received as input from the one or more sensors into account, adjusts the flow rate of infinitely variable pump according to said pre-set limits and information received as input, and sends output of adjustment to control panel.

20. The washing machine of claim 19, wherein said infinitely adjustable flow rate allows for selection from an uncountably infinite set of speeds.
